(19) United States
(12) Patent Application Publication
(10) Pub. No.: US 2026/0237880 A1
(43) Pub. Date: Aug. 13, 2026

(54) PARALLEL POWER DISTRIBUTION CIRCUIT DEVICE

(71) Applicant: ELECTRONICS AND TELECOMMUNICATIONS RESEARCH INSTITUTE, Daejeon (KR)

(72) Inventor: Soon Young EOM, Daejeon (KR)

(73) Assignee: ELECTRONICS AND TELECOMMUNICATIONS RESEARCH INSTITUTE, Daejeon (KR)

(21) Appl. No.: 19/530,743

(22) Filed: Feb. 5, 2026

(30) Foreign Application Priority Data
Feb. 11, 2025 (KR) 10-2025-0017189

(51) Int. Cl. H01P 5/19

(52) U.S. Cl. CPC H01P 5/19

(57) ABSTRACT

An embodiment of the present disclosure can design a power distribution circuit such that the RF characteristics of the entire power distribution circuit are not deteriorated by using a support structure that can maintain a constant gap between a center conductor and a ground conductor. The embodiment of the present disclosure proposes a method of inserting a plurality of 90° short-circuited parallel stub circuits that can serve as support structures within the power distribution circuit.

### CROSS-REFERENCE TO RELATED APPLICATION

This application claims the benefit of and priority to Korean Patent Application No. 10-2025-0017189, filed on February 11, 2025, the entire disclosure(s) of which is hereby incorporated herein by reference in its entirety.

### TECHNICAL FIELD

The present disclosure relates to a parallel power distribution circuit device.

### BACKGROUND

The following description merely provides background information related to the present embodiment and does not constitute prior art.

FIG. 1 illustrates a microstrip line structure widely used in high-frequency bands.

In the microstrip line structure 100, H represents the height between a center conductor and a ground conductor, W represents the width of the center conductor, t represents the thickness of the ground conductor, and Er represents the permittivity of a dielectric between the center conductor and the ground conductor. H represents the thickness of the dielectric between the center conductor and the ground conductor.

The center conductor and the ground conductor are maintained at a constant distance according to the dielectric interposed therebetween. However, the microstrip line structure 100 generally has the disadvantage of limited power consumption due to the thin conductors and dielectric loss caused by the imaginary component of the dielectric. The imaginary component represents the inefficiency of converting electrical energy into heat, resulting in energy loss. Therefore, a microstrip power distribution circuit implemented on a dielectric printed circuit board (PCB) suffers from low power consumption and high insertion loss. Low power consumption cannot meet high power requirements, and large insertion loss degrades circuit performance, causing signal quality degradation and reduced transmission efficiency.

### SUMMARY

The present disclosure provides a power distribution circuit device with a coaxial line structure having low loss and high power characteristics.

The present disclosure also provides a support structure capable of maintaining a constant gap between a center conductor and a ground conductor without a dielectric.

The objects to be achieved by the present disclosure are not limited to the objects mentioned above, and other objects not mentioned will be clearly understood by those skilled in the art from the description below.

According to an embodiment of the present disclosure, a parallel power distribution circuit device comprises: a cross-junction (C-junction) circuit with a parallel stub circuit added to the center of a T-junction circuit for distributing an input power supply signal.

According to an embodiment of the present disclosure, a parallel power distribution circuit device comprises: a center conductor and an outer conductor; and a C-junction circuit having a parallel stub circuit added to the center conductor.

According to an embodiment of the present disclosure, a parallel power distribution circuit device comprises: a lower conductor, a center conductor, and an upper conductor; and a C-junction circuit having a parallel stub circuit added to the lower conductor and electrically coupled to the center conductor, wherein an edge of a predetermined area of the lower conductor is removed, the center conductor is disposed in an area inside the removed edge, and an area outside the removed edge is in contact with the upper conductor.

The present disclosure can design a power distribution circuit device with a coaxial line structure having low loss and high power characteristics.

The present disclosure can design a support structure that can maintain a constant gap between a center conductor and a ground conductor such that the radio frequency (RF) characteristics of the entire power distribution circuit are not degraded. The coaxial line structure is configured without any dielectric material between the center conductor and the outer conductor.

The effects of the present disclosure are not limited to those mentioned above, and other unmentioned effects will be clearly understood by those skilled in the art from the description below. In particular, the parallel stub circuit simultaneously provides mechanical support for the center conductor and electrical impedance matching, which is not achievable in conventional T-junction structures.

### BRIEF DESCRIPTION OF THE DRAWINGS

FIG. 1 illustrates a microstrip line structure widely used in high-frequency bands.

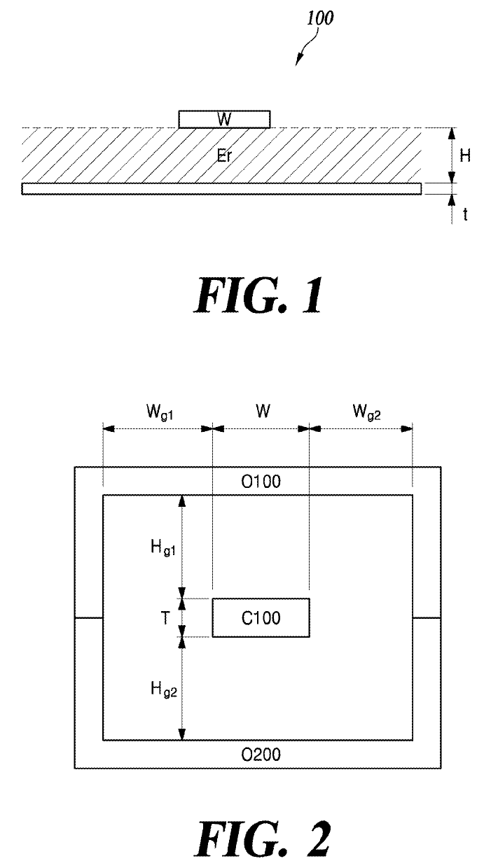

FIG. 2 illustrates a cross-sectional view of an AIR-TEM (Transverse Electromagnetic) coaxial line structure according to an embodiment of the present disclosure.

FIG. 3 illustrates configurations of conventional two-way uniform power distribution circuits using a T-junction circuit.

FIG. 4 illustrates configurations of two-way uniform power distribution circuits using a cross-junction (C-junction) circuit according to an embodiment of the present disclosure.

FIG. 5 illustrates electrical S-parameter characteristics of two-way uniform power distribution circuits using a conventional T-junction circuit and a C-junction circuit according to an embodiment of the present disclosure.

FIG. 6 illustrates a configuration of a four-way uniform power distribution circuit using the conventional T-junction circuit.

FIG. 7 illustrates a configuration of a four-way uniform power distribution circuit using the C-junction circuit according to an embodiment of the present disclosure.

FIG. 8 illustrates electrical S-parameter characteristics of four-way uniform power distribution circuits using the conventional T-junction circuit and the C-junction circuit according to an embodiment of the present disclosure.

FIG. 9 and FIG. 10 illustrate a parallel feed circuitry configuration of an array antenna designed using the C-junction circuit according to an embodiment of the present disclosure.

FIG. 11 is a structural diagram illustrating a method of manufacturing an array antenna.

FIG. 12 is a structural diagram illustrating an upper conductor of FIG. 11 turned over.

### DETAILED DESCRIPTION

Hereinafter, some embodiments of the present disclosure will be described in detail with reference to the accompanying drawings. In the following description, like reference numerals can designate like elements, even though the elements can be shown in different drawings. Further, the following description of some embodiments can omit, for the purpose of clarity and for brevity, a detailed description of related known components and functions when considered obscuring the subject of the present disclosure.

Various ordinal numbers or alpha codes such as “first”, “second”, “A”, “B”, “(a)”, “(b)”, etc., can be prefixed solely to differentiate one component from the other but not to necessarily imply or suggest the substances, order, or sequence of the components. Throughout this specification, when a part “includes” or “comprises” a component, the part is meant to allow for further including other components and to not exclude other components, unless specifically stated to the contrary. Terms such as “unit,” “module,” and the like can refer to units in which at least one function or operation is processed and they may be implemented by hardware, software, or a combination thereof.

The following detailed description is intended to describe exemplary embodiments of the present invention and is not intended to represent the only embodiments in which the present invention may be practiced.

An embodiment of the present disclosure can design a power distribution circuit such that the RF characteristics of the entire power distribution circuit are not deteriorated by using a support structure that can maintain a constant gap between a center conductor and a ground conductor. The embodiment of the present disclosure proposes a method of inserting a plurality of 90° short-circuited parallel stub circuits that can serve as support structures within the power distribution circuit.

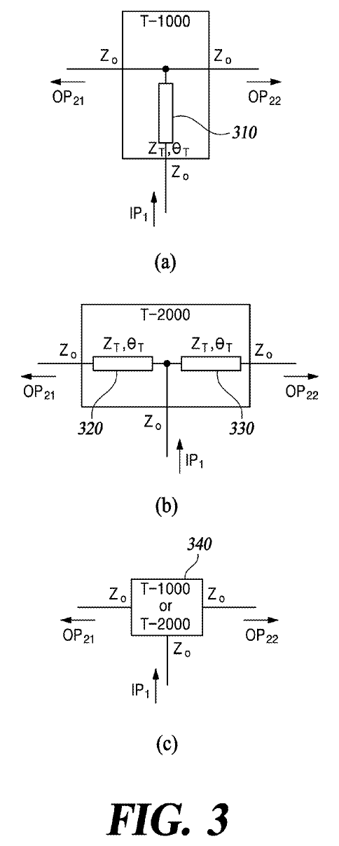

FIG. 2 illustrates a cross-section of an AIR-TEM coaxial line structure according to an embodiment of the present disclosure.

Reference numeral C100 represents the cross-section of a center conductor, which has a rectangular shape. The line width W, a design variable for C100, is closely related to the characteristic impedance, and the line thickness T is determined in consideration of high-power characteristics and circuit manufacturability (or implementation).

The outer conductor of the AIR-TEM coaxial line structure is composed of two structures (upper and lower structures). In the AIR-TEM coaxial line structure, air is filled as an internal dielectric of a coaxial line. Accordingly, the coaxial line structure is configured without any dielectric material between the center conductor and the outer conductor. TEM represents a coaxial line that transmits transverse electromagnetic waves. TEM mode is an electromagnetic mode in which electric fields and magnetic fields exist perpendicular to the direction of propagation, and represents the fundamental transmission mode that occurs primarily in coaxial lines.

Reference numeral O100 represents the upper structure of the outer conductor, the horizontal length L_{U1} of the upper structure is the sum of W_{g1}, W, and W_{g2} (L_{U1}=W_{g1}+W+W_{g2}), and the vertical length L _{U2} thereof is the sum of H_{g1} and 0.5T (L_{U2}=H_{g1}+0.5T). Reference numeral O200 represents the lower structure of the outer conductor, the horizontal length L_{D1} is the sum of W_{g1}, W, and Wg2 (L_{D1}=W_{g1}+W+W_{g2}), and the vertical length L_{D2} thereof is the sum of H_{g2} and 0.5T (L_{D2}=H_{g2}+0.5T). The thickness of the outer conductor does not affect electrical characteristics. In general, the rectangular center conductor of the AIR-TEM coaxial line structure is positioned at the center. At this time, the relationships H_{g1}=H_{g2} and W_{g1}=W_{g2} are satisfied. In a low characteristic impedance condition in which the rectangular line width W is greater than the line thickness T, the effect of the spacing H_{g1}=H_{g2} between the center conductor and the outer conductors is significant. On the other hand, in a high characteristic impedance condition in which the rectangular line width W is less than the line thickness T, the effect of the spacing W_{g1}=W_{g2} between the center conductor and the outer conductors is significant.

To this end, in the embodiment of the present disclosure, a 90° short-circuited parallel stub circuit for grounding is added at a certain position in order to separate (space) the center conductor C100 and the outer conductors O100 and O200 at a certain interval without using a dielectric structure. The optimal position where the 90° short-circuited parallel stub circuit is added is the center of a T-junction circuit distributed in two ways in parallel feed circuitry. The addition of the 90° short-circuited parallel stub circuit can improve the input matching performance within the operating band in addition to the function of supporting the center conductor C100. The 90° short-circuited parallel stub circuit reduces reflections that may occur at the input by matching the impedance of the input terminal with the characteristic impedance of the circuit within a frequency band, thereby enabling signals to be transmitted effectively. “90° short-circuit” is a concept used in transmission line theory and RF circuit design, in which one end of a transmission line whose electrical length corresponds to 90° (1/4 of the wavelength) at a specific frequency is short-circuited.

A parallel power distribution circuit device according to an embodiment of the present disclosure includes a cross-junction (C-junction) circuit with a parallel stub circuit added to the center of a T-junction circuit for distributing an input power supply signal.

The C-junction circuit is obtained by adding the parallel stub circuit having a 90° electrical length to a T-junction circuit. In other words, the C-junction circuit is a T-junction circuit with a parallel stub circuit having a wavelength of one-quarter. In this configuration, the parallel stub circuit simultaneously provides mechanical support for the center conductor and electrical impedance matching, which is not achievable in conventional T-junction structures.

The parallel stub circuit according to an embodiment of the present disclosure can resonate at a specific frequency or block a specific signal using reflection characteristics, and the length (electrical length) of the parallel stub circuit adjusts the input impedance depending on the frequency. These characteristics allow for formation of a short-circuit condition at a specific frequency, thereby blocking the frequency.

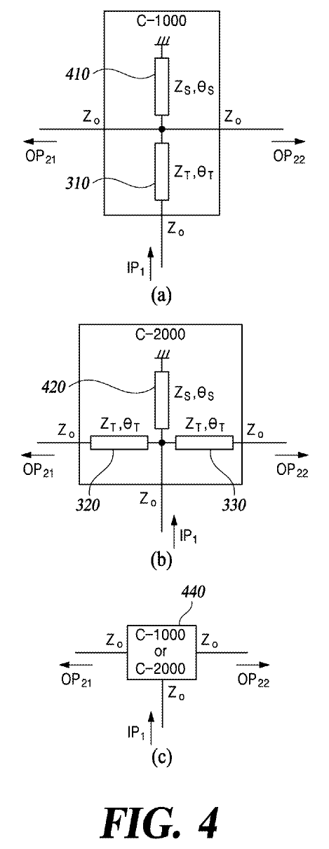

FIG. 3 illustrates configurations of conventional two-way uniform power distribution circuits using a T-junction circuit.

Conventional power distribution circuits use T-junction circuit elements and can be divided into a wideband input matching structure T1000 and a narrowband input matching structure T2000.

FIG. 3(a) illustrates a wideband input matching structure T1000 designed to maintain signal matching characteristics in a wide frequency band. A transmission line 310 has a characteristic impedance Z_{T} and the electrical length θ_{T} of an impedance converter line.

FIG. 3(b) illustrates a narrowband input matching structure T2000, which optimizes matching performance in a specific frequency band to provide high efficiency. Transmission lines 320 and 330 have a characteristic impedance Z_{T} and the electrical length θ_{T} of an impedance converter line.

FIG. 3(c) illustrates a two-way T-junction distribution circuit.

Reference numeral 340 represents a power distribution circuit based on a type-T1000 T-junction or type-T2000 T-junction, which serves to distribute an input signal IP₁ to two outputs OP₂₁ and OP₂₂.

The power distribution circuits of FIGS. 3(a), 3(b), and 3(c) may have one input terminal IP₂ and two output terminals IP₂₁ and IP₂₂.

The stub circuits 310, 320, and 330 have the characteristic impedance Z_{T} of the impedance converter line and the electrical length θ_{T} of the impedance converter line.

The characteristic impedance Z_{T} of the impedance converter line represents the matching characteristics of input and output impedances when a signal is transmitted through the line.

The electrical length θ_{T} of the impedance converter line determines a phase shift of a signal and is used to adjust performance at a specific frequency.

In the power distribution circuits of FIGS. 3(a), 3(b), and 3(c), there is no connection between the center conductor C100 and the outer conductors O100 and O200.

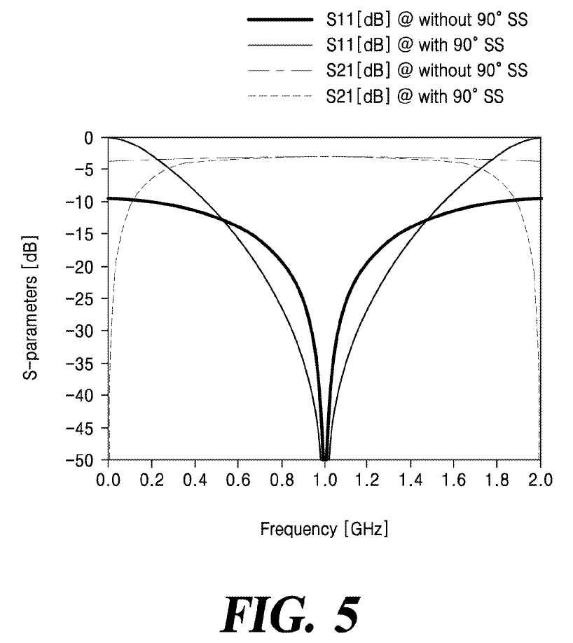

FIG. 4 illustrates configurations of two-way uniform power distribution circuits using a C-junction circuit according to an embodiment of the present disclosure.

When represented in a circuit configuration, the power distribution circuits according to an embodiment of the present disclosure include a waveguide input terminal for inputting a power supply signal, and a C-junction circuit with a parallel stub circuit added to the center of a T-junction circuit for distributing the input power supply signal. This illustrates the functional design and components of the power distribution circuit.

When represented in the cross-section form of an AIR-TEM coaxial line structure, the power distribution circuits according to an embodiment of the present disclosure include a center conductor, an outer conductor, and a C-junction circuit with a parallel stub circuit added to the center conductor. This focuses on the physical structure and morphological configuration of the power distribution circuit.

The power distribution circuits according to an embodiment of the present disclosure utilize a C-junction circuit element having a 90° short-circuited parallel stub circuit and can be divided into a wideband input matching structure C1000 and a narrowband input matching structure C2000.

FIG. 4 (a) illustrates the wideband input matching structure T1000), which is designed to maintain signal matching characteristics over a wide frequency band. A transmission line 310 has a characteristic impedance Z_{T} and an electrical length θ_{T} of an impedance converter line. A 90° short-circuited parallel stub circuit 410 has the characteristic impedance Zₛ of the parallel stub circuit and the electrical length θₛ of the parallel stub circuit. θₛ is designed to be 90° and 1/4 of the wavelength.

FIG. 4 (b) illustrates the narrowband input matching structure T2000, which provides high efficiency by optimizing matching performance in a specific frequency band. Transmission lines 320 and 330 have a characteristic impedance Z_{T} and an electrical length θ_{T} of an impedance transformer line. A 90° short-circuited parallel stub circuit 420 has the characteristic impedance Zₛ of the parallel stub circuit and the electrical length θₛ of the parallel stub circuit. θₛ is designed to be 90° and 1/4 of the wavelength.

FIG. 4 (c) illustrates a two-way C-junction distribution circuit.

Reference numeral 440 represents a power distribution circuit based on a Type-T1000 T-junction or Type-T2000 T-junction, which serves to distribute an input signal IP₁ to two outputs OP₂₁ and OP₂₂.

The power distribution circuits of FIGS. 4(a), 4(b), and 4(c) may have one input terminal IP₁ and two output terminals IP₂₁ and IP₂₂.

The differences between FIG. 3 and FIG. 4 are the 90° short-circuited parallel stub circuits 410, 420, and 440.

The 90° short-circuited parallel stub circu its 410 and 420 have the characteristic impedance of a parallel short-circuited stub line and the electrical length of the parallel short-circuited stub line.

The 90° short-circuited parallel stub circuit 410 is added in FIG. 4(a) compared to FIG. 3(a), the 90° short-circuited parallel stub circuit 420 is added in FIG. 4(b) compared to FIG. 3(b), and reference numeral is changed to 440 in FIG. 4(c) compared to FIG. 3(c).

A power distribution circuit according to an embodiment of the present disclosure has one portion where a center conductor C100 is connected to outer conductors O100 and O200 via a 90° short-circuited parallel stub circuit, and the 90° short-circuited parallel stub circuit physically secures the center conductor C100.

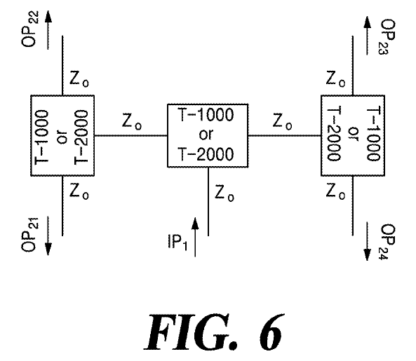

FIG. 5 illustrates electrical S-parameter characteristics of two-way uniform power distribution circuits using a conventional T-junction circuit and a C-junction circuit according to an embodiment of the present disclosure.

FIG. 5 shows comparison the electrical characteristics of a two-way uniform power distribution circuit using a conventional T-junction circuit and a two-way uniform power distribution circuit using a C-junction circuit according to an embodiment of the present disclosure. The graph shown in FIG. 5 shows electrical S-parameter characteristics simulated at a normalized frequency (fₙ = 1.0 GHz). The two-way uniform power distribution circuit using the C-junction circuit according to an embodiment of the present disclosure exhibits relatively superior input matching characteristics compared to the two-way uniform power distribution circuit using the conventional T-junction circuit.

In the graph shown in FIG. 5, the x-axis (frequency [GHz]) represents frequency variation (ranging from 0 to 2.0 GHz). The y-axis (S-parameters [dB]) represents the magnitudes of S-parameters in decibels (dB).

S11 represents the input reflection coefficient (the ratio of power reflected from the input).

S21 represents the transfer coefficient (the ratio of power transmitted from the input to the output).

In the graph shown in FIG. 5, the line 504 representing S11 [dB] @ without 90° SS represents the input reflection characteristics of a conventional T-junction circuit without a 90° short-circuited stub structure.

In the graph shown in FIG. 5, the line 502 representing S11 [dB] @ with 90° SS represents the input reflection characteristics of a C-junction circuit with a 90° short-circuited stub structure.

In the graph shown in FIG. 5, the line 508 representing S21 [dB] @ without 90° SS represents the power transfer characteristics of a conventional T-junction circuit.

In the graph shown in FIG. 5, the line 506 representing S21 [dB] @ with 90° SS represents the power transfer characteristics of a C-junction circuit.

The following description will distinguish between cases where the input reflection coefficient is S11 and cases where the input reflection coefficient is S21.

Case where input reflection coefficient is S11

A low S11 value indicates that the input signal is not reflected and is well-matched to the circuit.

In the graph shown in FIG. 5, it can be confirmed from the solid line 502 (representing the circuit according to the embodiment of the present disclosure) that S11 significantly decreases to -40 dB or less at a specific frequency band (e.g., fₙ = 1.0 GHz). This indicates minimal reflection and excellent input matching.

On the other hand, the thick line 504 (representing the conventional circuit) in the graph shown in FIG. 5 indicates that S11 is higher at the same frequency, exhibiting relatively poor input matching.

2) Case where power transfer coefficient is S21

A high S21 value indicates that power is efficiently transferred to the output.

In the graph shown in FIG. 5, the dotted line 506 (representing the circuit according to an embodiment of the present disclosure) indicates that power is effectively distributed in a specific frequency band.

In the graph shown in FIG. 5, the dotted line 508 (representing the conventional circuit) indicates that the transfer characteristics are relatively low or irregular.

Input matching characteristics (S11): The C-junction circuit according to an embodiment of the present disclosure exhibits superior input matching over a wide bandwidth (0.6 to 1.4 GHz, 80% bandwidth) compared to the conventional T-junction circuit.

Power transfer characteristics (S21): The C-junction circuit according to an embodiment of the present disclosure exhibits superior power transfer efficiency over a wide bandwidth (0.6 to 1.4 GHz, 80% bandwidth) and is advantageous for uniform power distribution.

As a result, it can be confirmed through FIG. 5 that the C-junction circuit according to an embodiment of the present disclosure has improved electrical performance compared to the conventional T-junction circuit.

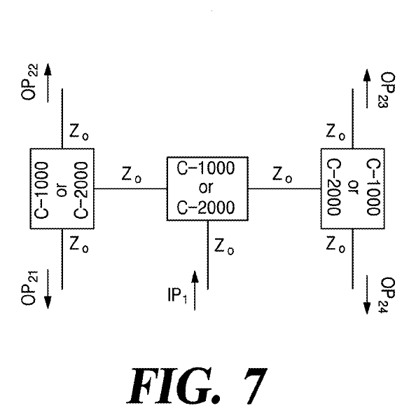

FIG. 6 illustrates a configuration of a four-way uniform power distribution circuit using the conventional T-junction circuit.

The 4-way uniform power distribution circuit using the conventional T-junction circuit distributes an input signal IP₁ to four outputs OP₂₁, OP₂₂,OP₂₃, and OP₂₄.

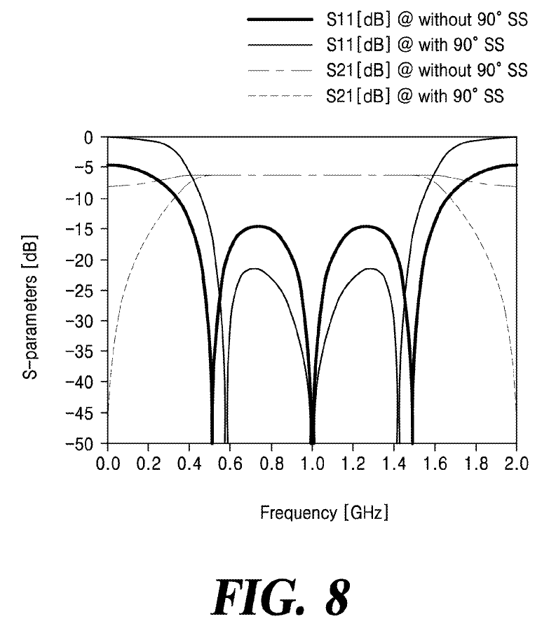

FIG. 7 illustrates a configuration of a four-way uniform power distribution circuit using the C-junction circuit according to an embodiment of the present disclosure.

The four-way uniform power distribution circuit using the C-junction circuit according to an embodiment of the present disclosure distributes an input signal IP

₁ to four outputs OP₂₁, OP₂₂,OP₂₃, and OP₂₄.

In the C-junction four-way uniform power distribution circuit structure according to an embodiment of the present disclosure, the center conductor C100 is connected to the outer conductors O100 and O200 at three points through a 90° short-circuited parallel stub circuit, and the 90° short-circuited parallel stub circuit serves to physically secure the center conductor C100.

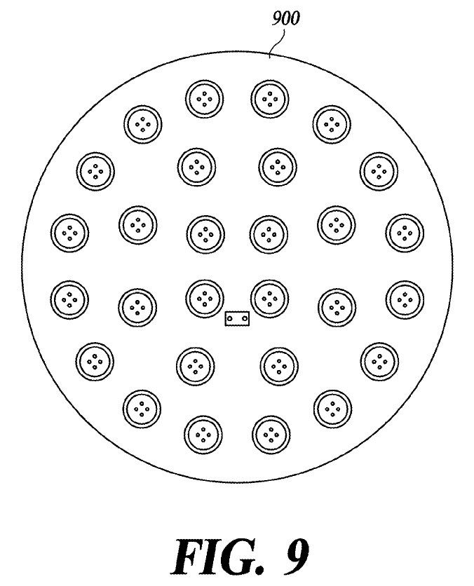

FIG. 8 illustrates the electrical S-parameter characteristics of four-way uniform power distribution circuits using the conventional T-junction circuit and the C-junction circuit according to an embodiment of the present disclosure.

FIG. 8 shows comparison of the electrical characteristics of a four-way uniform power distribution circuit using the conventional T-junction circuit and a four-way uniform power distribution circuit using the C-junction circuit according to an embodiment of the present disclosure, and shows results of simulations performed using electrical S-parameters at a normalized frequency (fₙ = 1.0 GHz) to compare the electrical characteristics. The S-parameters represent electrical characteristics used to analyze power transfer and reflection.

It can be confirmed through FIG. 8 that the four-way uniform power distribution circuit using the C-junction circuit according to an embodiment of the present disclosure exhibits relatively superior input matching characteristics over a wide bandwidth (0.6 to 1.4 GHz, 80% bandwidth) compared to the four-way uniform power distribution circuit using the conventional T-junction circuit. The four-way uniform power distribution circuit using the C-junction circuit according to an embodiment of the present disclosure better receives input signals, reduces loss, and efficiently distributes power compared to the four-way uniform power distribution circuit using the conventional T-junction circuit.

In the graph shown in FIG. 8, the x-axis (frequency [GHz]) represents frequency variation (ranging from 0 to 2.0 GHz). The y-axis (S-parameters [dB]) represents the magnitudes of S-parameters in decibels (dB).

S11 represents the input reflection coefficient (the ratio of power reflected from the input).

S21 represents the transfer coefficient (the ratio of power transmitted from the input to the output).

In the graph shown in FIG. 8, the line 804 representing S11 [dB] @ without 90° SS represents the input reflection characteristics of a conventional T-junction circuit without a 90° short-circuited stub structure.

In the graph shown in FIG. 8, the line 802 representing S11 [dB] @ with 90° SS represents the input reflection characteristics in a C-junction circuit including a 90° short-circuited stub structure.

In the graph shown in FIG. 8, the line 808 representing S21 [dB] @ without 90° SS represents the power transfer characteristics in the conventional T-junction circuit.

In the graph shown in FIG. 8, the line 806 representing S21 [dB] @ with 90° SS represents the power transfer characteristics in the C-junction circuit.

The following description will distinguish between cases where the input reflection coefficient is S11 and cases where the input reflection coefficient is S21.

Case where input reflection coefficient is S11

A low S11 value indicates that the input signal is not reflected and is well matched to the circuit.

In the graph shown in FIG. 8, it can be confirmed through the solid line 802 (representing the circuit according to an embodiment of the present disclosure) that S11 significantly decreases to -40 dB or less in a specific frequency band (e.g., fₙ = 1.0 GHz). This indicates minimal reflection and excellent input matching.

On the other hand, the thick line 804 (representing the conventional circuit) in the graph shown in FIG. 8 indicates that S11 is higher at the same frequency, exhibiting relatively poor input matching.

2) Case where power transfer coefficient is S21

A high S21 value indicates that power is efficiently transferred to the output.

The dotted line 806 (representing the circuit according to an embodiment of the present disclosure) indicates that power is effectively distributed in a specific frequency band.

The dotted line 808 (representing the conventional circuit) indicates that the transfer characteristics are relatively low or irregular.

Input matching characteristics (S11): The C-junction circuit according to an embodiment of the present disclosure exhibits superior input matching at a specific frequency (1.0 GHz) compared to the conventional T-junction circuit.

Power transfer characteristics (S21): The C-junction circuit according to an embodiment of the present disclosure exhibits superior power transfer efficiency and is advantageous for uniform power distribution.

As a result, as shown in FIG. 8, it can be confirmed that the C-junction circuit according to an embodiment of the present disclosure exhibits improved electrical performance compared to the conventional T-junction circuit.

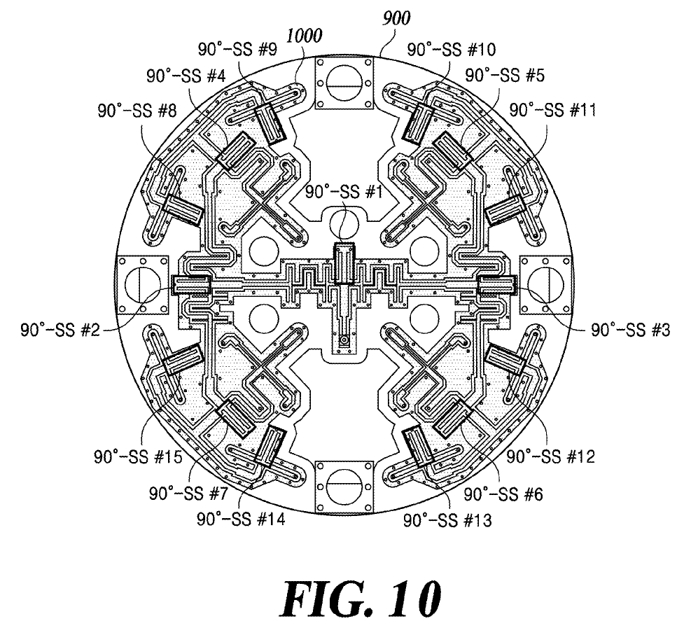

FIG. 9 and FIG. 10 illustrate a configuration of parallel feed circuitry of an array antenna designed using the C-junction circuit according to an embodiment of the present disclosure.

FIG. 9 and FIG. 10 illustrate an example of parallel feed circuitry of an array antenna having 28 array elements designed using the C-junction circuit according to an embodiment of the present disclosure.

FIG. 9 is a schematic diagram illustrating the top shape of an array antenna 900 having 28 array elements according to an embodiment of the present disclosure.

FIG. 10 is a schematic diagram illustrating the bottom shape of the array antenna 900 of FIG. 9.

The 28-way parallel feed circuitry does not use any dielectric structure to separate a center conductor C100 from outer conductors O100 and O200, and the entire structure is made of conductors. The center conductor C100 is supported using a total of fifteen 90° short-circuited parallel stub circuits, as shown in FIG. 10, and is also isolated from the outer conductors O100 and O200. In FIG. 10, the fifteen 90° short-circuited parallel stub circuits are denoted as 90°-SS#1 to 90°-SS#15. Reference numeral 1000 in FIG. 10 represents an edge, along which screw holes are formed. Assembly is performed through the screw holes. When the edge portion is removed, the inner region of the frame forms the central conductor, and the outer region of the frame forms the outer conductor.

A slot refers to an opening or gap formed to allow electromagnetic waves or signals to propagate along a specific path. In FIG. 2, the slots can be defined as W_{g1} and W_{g2}. W_{g1} and W_{g2} are structural elements that form a path for signal coupling or propagation between the center conductor C100 and the outer conductors O100 and O200.

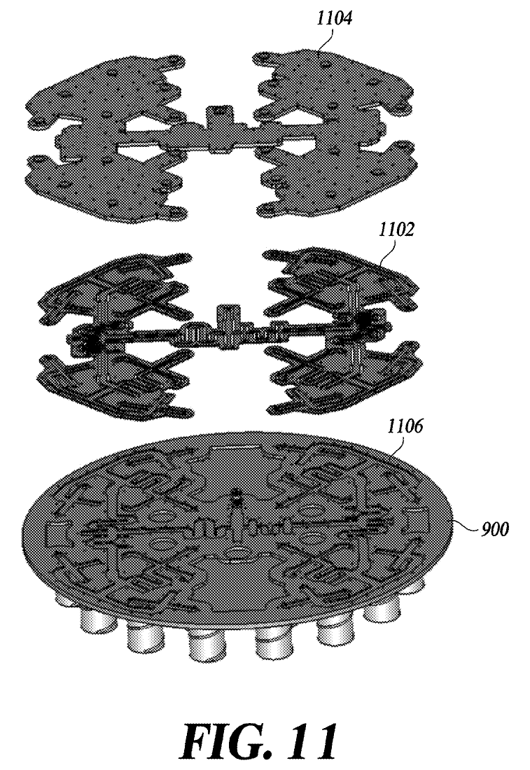

FIG. 11 is a structural diagram illustrating a method of manufacturing an array antenna.

The upper structure of the outer conductor in FIG. 2 is referred to as an upper conductor, and the lower structure of the outer conductor is referred to as a lower conductor.

Reference numeral 900 denotes the lower conductor, which is the same as the component 900 in FIG. 9 and FIG. 10.

Reference numeral 1102 denotes the center conductor, and reference numeral 1104 denotes the upper conductor.

The lower conductor has screw holes formed along the edge 1106.

The center conductor 1102 and the upper conductor 1104 have screw holes formed at positions corresponding to those of the lower conductor 900.

The lower conductor serves as a cover for the parallel feed circuitry for supplying power to the array elements, and is assembled with the screw holes of the upper and center conductors through the screw holes formed along the edge 1106. For reference, the center conductor 1102 includes the edge portion serving as a grounding element that contacts the upper and lower conductors, and a parallel feed circuit portion for supplying power to the array elements. Connection between these two portions is enabled by the 90° short-circuited parallel stub circuits 420 included in the C-junction circuit proposed in the present disclosure, thus offering the advantage of integrated manufacturing.

The lower conductor 900 serves as a grounding base mechanism for the array antenna, and the array elements are mounted on the opposite side thereof. As shown in FIG. 11, a portion of the interior is removed to provide an air gap at regular intervals when attaching the center conductor 1102.

The upper conductor 1104 serves as a cover for the parallel feed circuitry, and a portion of the interior is removed to provide an air gap identical or similar to the interior of the lower conductor 900 when attaching the center conductor 1102.

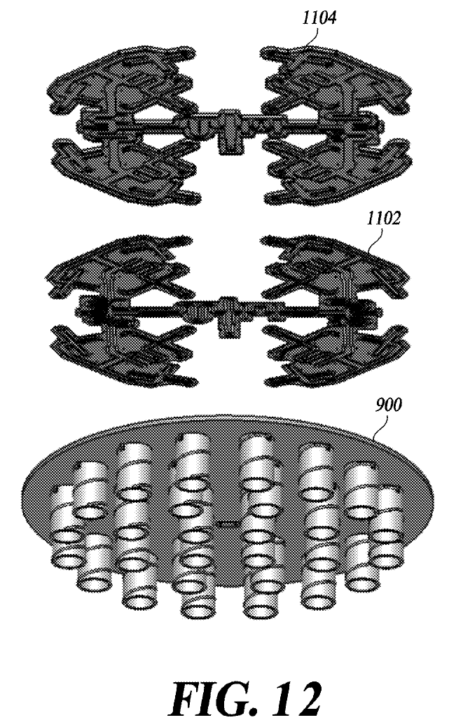

FIG. 12 is a diagram illustrating the structure of the upper conductor 1104 of FIG. 11, turned over, visually representing the shape viewed from the opposite side of the upper conductor 1104 of FIG. 11. The internal structure of the upper conductor 1104 and the shape with certain portions removed can be confirmed through FIG. 12.

Additionally, the 28-way parallel feed circuitry uses six additional short-circuits due to a circuit used to compensate for the broadband phase dispersion characteristics.

The array antenna with 28 array elements designed using the C-junction circuit proposed in the present disclosure has the advantage of providing both low-loss and high-efficiency characteristics because the parallel feed circuitry is composed of only conductors. Due to these characteristics, the array antenna according to the embodiment of the present disclosure can be widely utilized as a high-power transmission antenna.

The present disclosure can design a support structure that can maintain a constant gap between a center conductor and a ground conductor such that the radio frequency (RF) characteristics of the entire power distribution circuit are not degraded. The coaxial line structure is configured without any dielectric material between the center conductor and the outer conductor.

The effects of the present disclosure are not limited to those mentioned above, and other unmentioned effects will be clearly understood by those skilled in the art from the description below. In particular, the parallel stub circuit simultaneously provides mechanical support for the center conductor and electrical impedance matching, which is not achievable in conventional T-junction structures.

At least some of the components described in the exemplary embodiments of the present disclosure may be implemented as hardware elements, including at least one or a combination of a digital signal processor (DSP), a processor, a network controller, an application-specific integrated circuit (ASIC), a programmable logic device (FPGA), and other electronic devices. Furthermore, at least some of the functions or processes described in the exemplary embodiments may be implemented in software, and the software may be stored in a recording medium. At least some of the components, functions, and processes described in the exemplary embodiments of the present disclosure may be implemented as a combination of hardware and software.

What is claimed is:

1. A parallel power distribution circuit device comprising:
a cross-junction (C-junction) circuit with a parallel stub circuit added to the center of a T-junction circuit for distributing an input power supply signal.

2. The parallel power distribution circuit device of claim 1, wherein the C-junction circuit has the parallel stub circuit having a 90° electrical length added to the T-junction circuit.

3. The parallel power distribution circuit device of claim 1, wherein the C-junction circuit is implemented between a center conductor and an outer conductor, and the C-junction circuit has the parallel stub circuit added to the center conductor.

4. The parallel power distribution circuit device of claim 1, wherein the parallel stub circuit is configured to have a predetermined characteristic impedance and a 90° electrical length.

5. The parallel power distribution circuit device of claim 1, wherein the parallel stub circuit matches an impedance of an input terminal to the characteristic impedance of the circuit within a frequency band.

6. The parallel power distribution circuit device of claim 1, wherein the parallel stub circuit blocks a specific signal within a specific frequency band.

7. The parallel power distribution circuit device of claim 1, further comprising a waveguide input terminal to which the power supply signal is input.

8. The parallel power distribution circuit device of claim 1, wherein the C-junction circuit provides low-loss and high-power characteristics.

9. The parallel power distribution circuit device of claim 1, wherein the C-junction circuit performs at least one of two-way uniform power distribution and four-way uniform power distribution.

10. The parallel power distribution circuit device of claim 9, wherein N-way parallel feed circuitry is extended into a parallel feed circuitry having N output ports by hierarchically connecting or combining the C-junction circuits.

11. A parallel power distribution circuit device comprising:
a center conductor and an outer conductor; and
a C-junction circuit having a parallel stub circuit added to the center conductor.

12. The parallel power distribution circuit device of claim 11, wherein the C-junction circuit has the parallel stub circuit having a 90° electrical length added to the center conductor.

13. The parallel power distribution circuit device of claim 11, wherein the C-junction circuit has a parallel stub circuit having a wavelength of one quarter added to the center conductor.

14. The parallel power distribution circuit device of claim 11, wherein the parallel stub circuit is secured to the outer conductor using a grounding function.

15. The parallel power distribution circuit device of claim 11, wherein the parallel stub circuit provides a function of supporting the center conductor and a function of separating or isolating the center conductor from the outer conductor.

16. The parallel power distribution circuit device of claim 11, wherein the parallel stub circuit is configured to have a predetermined characteristic impedance and an electrical length of 90°.

17. The parallel power distribution circuit device of claim 11, wherein the parallel stub circuit matches an impedance of an input terminal to the characteristic impedance of the circuit within a frequency band.

18. The parallel power distribution circuit device of claim 11, wherein the C-junction circuit provides low-loss and high-output characteristics.

19. The parallel power distribution circuit device of claim 11, wherein the C-junction circuit performs at least one of two-way uniform power distribution and four-way uniform power distribution.

20. A parallel power distribution circuit device comprising:
a lower conductor, a center conductor, and an upper conductor; and
a C-junction circuit having a parallel stub circuit added to the lower conductor and electrically coupled to the center conductor,
wherein an edge of a predetermined area of the lower conductor is removed, the center conductor is disposed in an area inside the removed edge, and an area outside the removed edge is in contact with the upper conductor.
